(19) United States
(12) Patent Application Publication
(10) Pub. No.: US 2005/0067896 A1
(43) Pub. Date: Mar. 31, 2005

(54) Apparatus for preventing slipping of vehicle on slope

(75) Inventors: Su-Byeong Kim, Incheon (KR); Jong-Hyeung Kim, Seoul (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Yongin-shi (KR)

(21) Appl. No.: 10/725,363

(22) Filed: Dec. 3, 2003

(30) Foreign Application Priority Data
Sep. 29, 2003 (KR) 10-2003-0067239

(51) Int. Cl. B60T 8/32

(52) U.S. Cl. 303/191

(57) ABSTRACT

The present invention relates to an apparatus for preventing slipping of a vehicle on a slope, having a brake hydraulic circuit between a master cylinder and a wheel cylinder, whereby brake hydraulic pressure of the brake continues its operation on the wheel cylinder even when a driver releases a brake pedal.

### RELATED APPLICATIONS

The present disclosure relates to subject matter contained in priority Korean Application No. 10-2003-0067239, filed on Sep. 29, 2003, which is herein expressly incorporated by reference in its entirety.

### BACKGROUND OF THE INVENTION

1. Field of the Invention

The present invention relates to an apparatus for preventing slipping of a vehicle on a slope, having a brake hydraulic circuit between a master cylinder and a wheel cylinder, whereby brake hydraulic pressure of the brake continues its operation on the wheel cylinder even when a driver releases a brake pedal.

2. Description of the Related Art

In general, when a driver tries to start his or her car after a stop on a hill, the driver releases a brake pedal and then steps on an accelerator pedal. This general principle applies to manual transmission (M/T) cars and to hybrid electric vehicles (HEV) whose gas mileage and harmful exhaust gas are remarkably low, compared to existing general motor vehicles, by installing an internal combustion engine and a battery engine of an electric motor vehicle simultaneously or by reducing the weight of the vehicle to minimize air resistance. Many times the car skids backward in the above case because driving force for restarting the car on the hill is not sufficient. Nevertheless, whether to keep or to release brake pressure through the operation of a clutch is not an important issue as far as the automatic transmission (A/T) cars are concerned because of a structural problem involved. In general, A/T cars do not slip backward since revolution per minute (rpm) is forced to increase in engine idling state. However, if the rpm is set very high, even though slipping of the vehicle on a higher slope may be prevented, the vehicle could start rapidly as soon as the driver takes his or her foot off the brake pedal on the flat, and the energy efficiency thereof will considerably be reduced during traffic jams.

### SUMMARY OF THE INVENTION

It is, therefore, an object of the present invention to provide an apparatus for preventing slipping of a vehicle on a slope, capable of preventing the vehicle from rolling backward or slipping on the slope and protecting against rapid start of the vehicle on the flat.

To achieve the above object, there is provided an apparatus for preventing slipping of a vehicle on a slope, wherein the apparatus is installed at a brake hydraulic circuit connecting a master cylinder to wheel cylinders, in order to apply brake hydraulic pressure into the wheel cylinders even after a brake pedal is released, the apparatus including: solenoid valves for shutting the brake hydraulic circuits; and variable orifices for variably reducing brake force of the wheel cylinders after the brake pedal is released, by taking advantage of a brake fluid flow to the master cylinder, wherein the solenoid valves and the variable orifices are connected to the brake hydraulic circuits in parallel.

In a preferred embodiment, the brake hydraulic pressure in the wheel cylinders is gradually reduced by means of the variable orifices even when the brake pedal is released, so more time is secured for preventing backward slipping of the vehicle as a driver starts the vehicle on the slope after a stop, and the vehicle is protected against rapid start on the flat that usually accompanies with an increased rpm.

In a preferred embodiment, in case that a higher brake hydraulic pressure than a designated pressure is generated in the wheel cylinders while the brake hydraulic circuits are being shut down, the apparatus further includes relief valves, which are connected to the solenoid valves and the variable orifices in parallel, for lowering the brake hydraulic pressure in the wheel cylinders down to the designated pressure by the release of the brake pedal, and thereby, shortening the time needed to completely brake the car.

Further, in case that the brake hydraulic circuits are shut down, the apparatus includes check valves, which are connected to the solenoid valves and the relief valves in parallel, for transferring the brake hydraulic pressure generated from the master cylinder to the wheel cylinders. Therefore, even though the driver might increase the foot pressure on the brake pedal, the brake hydraulic pressure is transferred to the wheel cylinders against the brake hydraulic pressure of the master cylinder, and thus, the driver can more easily operate the brake pedal.

### BRIEF DESCRIPTION OF THE DRAWINGS

The above objects, features and advantages of the present invention will become more apparent from the following detailed description when taken in conjunction with the accompanying drawings, in which:

FIG. 1 is the configuration of a hydraulic brake circuit of a hydraulic brake, adopting an apparatus for preventing slipping of a vehicle according to a preferred embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

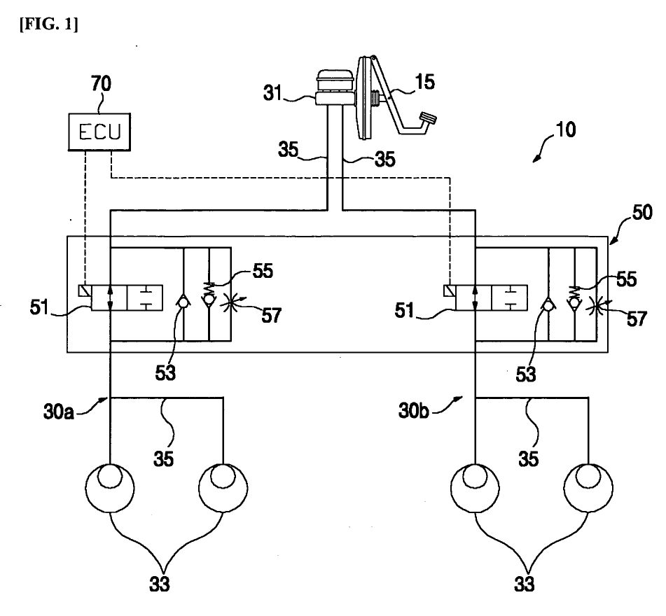

FIG. 1 is the configuration of a brake hydraulic circuit of a hydraulic brake, adopting an apparatus for preventing slipping of a vehicle according to a preferred embodiment of the present invention. As shown in the drawing, the brake hydraulic circuit of the hydraulic brake 10 includes a master cylinder 31, wheel cylinders 33, and a brake fluid pipe 35 connecting the master cylinder 31 with the individual wheel cylinders 33. Since the brake plays a critical role in safe driving, two separate brake hydraulic circuit systems 30 30a and 30b are preferably used. Therefore, although one of the brake hydraulic circuit systems may be out of order, the other one serves to provide minimum brake force.

The master cylinder 31 provides brake hydraulic pressure that engages the vehicle, according to a given force applied to a brake pedal 15 by the driver.

The brake fluid pipe 35 is used as a pathway for transferring brake fluid provided by the master cylinder 31 to the wheel cylinders 33. In case that the brake hydraulic pressure in the wheel cylinders 33 is higher than that of the master cylinder 31, the brake fluid flows from the wheel cylinder 33 to the master cylinder 33 via the brake fluid pipe 35. The brake fluid pipe 35 is connected to each of the two brake hydraulic circuit systems 30a and 30b, respectively. Meanwhile, there are two types of wheel control method: one is a cross system wherein the brake hydraulic circuit 30a controls the right front wheel and the left rear wheel and the other brake hydraulic circuit 30b controls the left front wheel and the right rear wheel, and the other is a front/rear split system wherein the brake hydraulic circuit 30a controls the front wheels on both sides and the other brake hydraulic circuit 30b controls the rear wheels on both sides.

The wheel cylinder 33 is installed at each wheel, and converts the hydraulic pressure of the brake fluid being provided by the master cylinder 31 and transferred via the brake fluid pipe 35 into brake force.

An apparatus for preventing slipping of the vehicle (i.e. an anti-skid apparatus) 50 is installed in the brake hydraulic circuit 30. This apparatus applies the brake hydraulic pressure to the wheel cylinders 33 even when the driver takes his or her foot off the brake pedal 15, and is composed of solenoid valves 51 and relief valves 55.

The solenoid valve 51 is actuated by an electric signal provided from an electronic control unit (ECU) 70, blocking brake fluid flow into the brake fluid pipe 35 in close state and maintaining the brake fluid hydraulic pressure applied to the wheel cylinders 33. Particularly, FIG. 1 illustrates two solenoid valves 5 being opened. With the application of the solenoid valves 51, even when the driver takes his or her foot off the brake pedal 15 on the slope, the brake hydraulic pressure in the wheel cylinders 33 is maintained, and the wheels of the vehicle do not roll backward or skid on the slope.

A variable orifice 57 is circulated to the master cylinder 31 and the wheel cylinders 33 whether or not the solenoid valves 51 are opened. That is to say, the variable orifice 57 is able to circulate the brake fluid at a predetermined speed, using a brake hydraulic pressure difference between the master cylinder 31 and the wheel cylinders 33. Especially in case that the solenoid valves 51 are closed and the driver takes his or her foot off the brake pedal 15 or relieves the brake pedal, the variable orifice 57 ensures that the brake fluid slowly flows into the master cylinder 31, thereby lowering the brake hydraulic pressure of the wheel cylinder 33 to a designated speed. To be short, when the driver takes his or her foot from the brake pedal or releases the brake pedal, it is the variable orifice 57 that gradually lowers the brake force even if the solenoid valves 51 are closed. The decompression delay can be adjusted by changing the diameter of the variable orifice. Hence, after a designated time, the brake force becomes weak enough to start the vehicle using the driving force thereof.

Check valves 53, although optional components, play a role of transferring the brake hydraulic pressure generated from the master cylinder 31 to the wheel cylinders 33 in case that the driver steps on the brake pedal 15 while the solenoid valves 51 are being closed. Particularly, these check valves 53 are effective when the brake hydraulic pressure exceeds the brake hydraulic pressure of the wheel cylinders 33 because they increase the brake hydraulic pressure of the wheel cylinders 33 in response to the increased foot pressure on the brake pedal 14.

Like the check valves, relief valves 55 are also optional and installed only when needed. When the driver generates a higher brake hydraulic pressure than a designated pressure (the critical pressure of the relief valve) on the wheel cylinders 33 while the solenoid valves 51 are being closed, the relief valves 55 quickly lower the brake hydraulic pressure of the wheel cylinders 33 down to the designated pressure by releasing of the brake pedal 15. Therefore, when the brake hydraulic pressure in the wheel cylinders 33 reaches the critical pressure of the relief valves 55, the relief valves 55 are closed and the brake hydraulic pressure of the wheel cylinders 33 is reduced, consequently preventing the vehicle from slipping. Besides, the relief valves 55, as a supplementary component of the variable orifice 57, can resolve the decompression delay problem associated with the reduction of the brake hydraulic pressure in the wheel cylinders 33.

As depicted in FIG. 1, the solenoid valves 51, the check valves 53, the relief valves 55 and the variable orifices 57 are connected in parallel to the brake hydraulic circuits, forming a ring-shaped pathway.

The operation of the apparatus for preventing slipping of a vehicle 50 (i.e. anti-skid apparatus) is now discussed.

When the driver needs to stop his or her vehicle on a slop or the uphill side of a trail, the driver steps on the brake pedal 15 to prevent his or her vehicle from rolling backward or slipping due to the deadweight (or dead load). As a result thereof, the brake fluid inside of the master cylinder 31 is compressed and thus, the brake hydraulic pressure therein is increased. This increased brake hydraulic pressure in turn causes the brake fluid to flow, and is transferred to the wheel cylinders 33 through the brake fluid pipe 35 and the open solenoid valves 51. The brake fluid being transferred is converted to the brake force for braking the wheels, whereby the vehicle can stop on the slope.

As the electronic control unit (ECU) 70 finds out that the vehicle stopped, it closes the solenoid valves 51, and maintains the brake hydraulic pressure in the wheel cylinders 33. Although the driver increases the foot pressure on the brake pedal 15 while the solenoid valves 51 are closed, the ECU 70 is capable of increasing the brake force by means of the check valves 53.

To climb the slope later, the driver takes his or her foot off the brake pedal 15 and steps on an accelerator pedal (not shown). Before stepping on the accelerator pedal, since the solenoid valves 51 are being closed, the brake hydraulic pressure in the wheel cylinders 33, as aforementioned, flows only to the relief valves 55 and the variable orifices 57. When the decompressing brake hydraulic pressure reaches the critical pressure of the relief valve 55, the relief valves 55 are closed, the brake fluid flows only to the variable orifices 57 having a small diameter so the vehicle does not slid on the slope. As discussed before, the decompression delay can be adjusted by changing the diameter of the variable orifice. Hence, when the driver steps on the accelerator pedal, the solenoid valves 51 are opened, and the brake hydraulic pressure in the wheel cylinders 33 is rapidly reduced, completely releasing the brake force. In this manner, the vehicle is provided with a sufficient driving force, and ready to clime on the hill.

In conclusion, the simple variable orifice enables the apparatus for preventing slipping of the vehicle on the slope of the invention to be applicable, regardless of the kind of power transmission system (e.g. A/T, M/T CVT). For instance, when the driver steps on the accelerator pedal after stopping on the slope, the apparatus of the invention prevents the vehicle from rolling backward or from slipping by maintaining the brake hydraulic pressure in the wheel cylinder at the critical pressure of the relief valve, and not releasing the brake pressure of the brake caliper quickly until the driving force of the engine is increased enough. Particularly, the invention can be effectively used for A/T cars in view that it can improve energy efficiency of the A/T cars by reducing the idling rpm, and ensures that the cars do not skid from highly steep curves (e.g. parking lot entrance of some department store). Besides, the application of the variable orifice makes it possible to adjust the operation time of the apparatus, according to the driving habits and the driving experiences of drivers. Further, the present invention is applicable to diverse models, so there is no need to develop specific types of apparatus for certain kinds of car models.

In addition, in case that a higher brake hydraulic pressure than the designated pressure is generated in the wheel cylinders while the brake hydraulic circuits are being shut down, the relief valves, which are connected to the solenoid valves and the variable orifices in parallel, lower the brake hydraulic pressure in the wheel cylinders down to the designated pressure by the release of the brake pedal, and thereby, shorten the time needed to completely brake the car.

Further, in case that the brake hydraulic circuits are shut down, the check valves, which are connected to the solenoid valves and the relief valves in parallel, transfer the brake hydraulic pressure generated from the master cylinder to the wheel cylinders. Therefore, even though the driver might increase the foot pressure on the brake pedal, the brake hydraulic pressure is transferred to the wheel cylinders against the brake hydraulic pressure of the master cylinder, and thus, the driver can more easily operate the brake pedal.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

1. An apparatus for preventing slipping of a vehicle on a slope, wherein the apparatus is installed at a brake hydraulic circuit connecting a master cylinder to wheel cylinders, in order to apply brake hydraulic pressure into the wheel cylinders even after a brake pedal is released, the apparatus comprising:
a plurality of solenoid valves that shut the brake hydraulic circuit; and
a plurality of variable orifices that variably reduce brake force of the wheel cylinders after the brake pedal is released, by utilizing a brake fluid flow to the master cylinder, wherein the solenoid valves and the variable orifices are connected to the brake hydraulic circuit in parallel, whereby changing the diameters of the variable orifices provides an adjustable delay in reducing the brake force of the wheel cylinders.

2. The apparatus according to claim 1, further comprising:
a plurality of relief valves connected to the solenoid valves and the variable orifices in parallel, respectively, that reduce the brake hydraulic pressure in the wheel cylinders to a designated pressure by a release of the brake pedal in case that a higher brake hydraulic pressure than the designated pressure is generated in the wheel cylinders while the brake hydraulic circuit is shut down.

3. The apparatus according to claim 1, further comprising:
a plurality of check valves connected to the solenoid valves and the variable orifices in parallel, respectively, that transfer brake hydraulic pressure generated from the master cylinder to the wheel cylinders while the brake hydraulic circuit is shut down.

4. The apparatus according to claim 2, further comprising:
a plurality of check valves connected to the solenoid valves and the variable orifices in parallel, respectively, that transfer brake hydraulic pressure generated from the master cylinder to the wheel cylinders while the brake hydraulic circuit is shut down.
